(19) United States
(12) Patent Application Publication
(10) Pub. No.: US 2026/0149733 A1
(43) Pub. Date: May 28, 2026

(54) METHOD AND SYSTEM FOR DETECTING AND PROTECTING AGAINST INTRUSION IN AN IN-VEHICLE NETWORK

(71) Applicants: HYUNDAI MOTOR COMPANY, Seoul (KR); KIA CORPORATION, Seoul (KR)

(72) Inventors: Jeong Seok Jo, Hwaseong-si (KR); Jiyong Han, Hwaseong-si (KR)

(73) Assignees: HYUNDAI MOTOR COMPANY, Seoul (KR); KIA CORPORATION, Seoul (KR)

(21) Appl. No.: 19/286,020

(22) Filed: Jul. 30, 2025

(30) Foreign Application Priority Data
Nov. 25, 2024 (KR) 10-2024-0169534

(51) Int. Cl. H04L 9/40

(52) U.S. Cl. CPC H04L 63/1441; H04L 63/1433

(57) ABSTRACT

A method of detecting and preventing an intrusion within an in-vehicle network includes determining that an attack according to a threat scenario has occurred and determining to which stage of an attack path of the threat scenario the attack determine to have occurred corresponds, where the attack path of the threat scenario includes a detection stage and a protection stage. The method also includes, based on determining that the stage of the attack path to which the attack correspond is the detection stage, operating an intrusion detection and prevention system as an intrusion detection system.

### CROSS-REFERENCE TO RELATED APPLICATION

This application claims priority to and the benefit of Korean Patent Application No. 10-2024-0169534, filed on Nov. 25, 2024, the entire contents of which are hereby incorporated herein by reference.

### BACKGROUND

### 1. Technical Field

The present disclosure relates to a method and system for detecting and protecting against an intrusion in an in-vehicle network.

### 2. Discussion of Related Art

Due to changes in the automotive industry environment, electronic devices among components and systems in vehicles are increasing, and this is also increasing the importance of software. In addition, various functions and services are provided inside the vehicle through communication between electronic control units (ECUs) through a distributed network. For example, various communication networks such as a controller area network (CAN), a local interconnect network (LIN), a Media Oriented System Transport (MOST) network, automotive Ethernet, a FlexRay network, etc. are being developed and applied between ECUs.

Accordingly, the importance of automobile functional safety is being emphasized, and international standards for vehicle design considering functional safety have been established. Automobile functional safety includes reducing the failure rate of automobile electrical components to increase product reliability, increasing driver safety through fault diagnosis and safety mechanisms, increasing vehicle availability through product design processes and maintenance systems, etc.

Furthermore, automobiles are evolving to provide various services through communication between components inside the vehicle, communication between the vehicle and the surrounding traffic infrastructure (vehicle-to-infrastructure (V2I)), communication between the vehicle and surrounding vehicles (vehicle-to-vehicle (V2V)), and communication between the vehicle and the driver's smartphone using information and communication technology. The increase in the share of these electrical components and software and the provision of services through communication connections are increasing the possibility of exposure to security risks. Accordingly, an intrusion detection and prevention system (IDPS) is being developed for the cybersecurity of vehicles. An IDPS may monitor an in-vehicle network to detect threats and take action to block detected threats. Such an IDPS is included in vehicles when the vehicles are mass-produced, but there may be a problem when new threats are detected or bypassed threats occur after mass production, as there is no countermeasure.

### SUMMARY

Implementations of the present disclosure provide a method and a system for detecting and protecting against threats in an in-vehicle network.

Implementations of the present disclosure provide an intrusion detection and prevention system and method capable of detecting threats and performing security measures corresponding thereto even when an attack that bypasses security measures deployed in a vehicle occurs.

Objects according to the technical spirit of the present disclosure are not limited to the above-described objects and other objects that are not described herein may be more clearly understood by those having ordinary skill in the art from the following descriptions.

According to an aspect of the present disclosure, a method of detecting and preventing an intrusion in an in-vehicle network is provided. The method includes determining that an attack according to a threat scenario has occurred and determining to which stage of an attack path of the threat scenario the attack determined to have occurred correspond. where the attack path of the threat scenario includes a detection stage and a protection stage. The method also includes, based on determining that the stage of the attack path to which the attack corresponds is the detection stage, operating an intrusion detection and prevention system as an intrusion detection system.

The method may further include detecting threat data while the intrusion detection and prevention system is operating as the intrusion detection system and determining to which stage of the attack path of the threat scenario the attack corresponds based on the detected threat data. The method also includes, based on determining that that stage of the attack path to which the attack corresponds based on the threat data is the protection stage, determining protection rule sets based on the threat scenario and executing the determined protection rule sets.

The method may further include transmitting information related to the detected threat data to a server.

The server may be a vehicle security operations center.

The method may further include receiving a protection rule set for the detected threat data from the server.

At least one of the protection rule sets determined based on the threat scenario may be to block transmission of related data.

The threat scenario and the attack path may be a threat scenario and an attack path based on vehicle security threat analysis and risk assessment.

Determining to which stage of the attack path of the threat scenario the attack determined to have occurred corresponds may include comparing the attack path of the threat scenario with a rule set for detecting intrusions stored in a database.

According to another aspect of the present disclosure, an intrusion detection and prevention system is provided. The intrusion detection and prevention system includes a communication module, a memory, and a processor. The processor is configured to determine that an attack according to a threat scenario has occurred and determine to which stage of an attack path of the threat scenario the attack determined to have occurred corresponds, wherein the attack path of the threat scenario includes a detection stage and a protection stage. The processor is also configured to, based on determining that the attack corresponds to the detection stage, operate as an intrusion detection system.

The processor may be configured to detect threat data while operating as the intrusion detection system and determine to which stage of the attack path of the threat scenario the attack corresponds based on the detected threat data. The processor is also configured to, based on determining that the stage to which the attack correspond based on the threat data is the protection stage, determine a protection rule set based on the threat scenario and execute the determined protection rule set.

The processor may be configured to use the communication module to transmit information related to the detected threat data to a server.

The server may be a vehicle security operations center.

The processor may be configured to use the communication module to receive a protection rule set for the detected threat data from the server.

The protection rule set determined based on the threat scenario may be to block transmission of related data.

The threat scenario and the attack path may be a threat scenario and an attack path based on vehicle security threat analysis and risk assessment

The processor may be configured to determine to which stage of the attack path of the threat scenario the attack determined to have occurred corresponds by comparing the attack path of the threat scenario with a rule set for detecting intrusions stored in a database.

The intrusion detection and prevention system may be provided as a plurality of intrusion detection and prevention systems placed at one or more of inside a central gateway, between the central gateway and a sub gateway, inside the sub gateway, between the sub gateway and an electronic control unit, or inside the electronic control unit.

### BRIEF DESCRIPTION OF THE DRAWINGS

The above and other objects, features, and advantages of the present disclosure should become more apparent to those of ordinary skill in the art from the following description taken in conjunction with the accompanying drawings, in which:

FIG. 1 is a diagram illustrating an example of an intrusion that may occur by a device outside a vehicle in the entire system in which an intrusion detection and prevention system in an in-vehicle network is connected to a server, according to an implementation of the present disclosure;

FIG. 2 is a diagram illustrating an example of a location at which an intrusion detection and prevention system may be placed in an in-vehicle network, according to an implementation of the present disclosure;

FIG. 3 is a diagram illustrating an example of a vehicle security threat analysis and risk assessment scenario, according to an implementation of the present disclosure;

FIG. 4 is a flowchart of a process in which an intrusion detection and prevention system for detecting and protecting against threats in an in-vehicle network, according to an implementation of the present disclosure; and

FIG. 5 is a configuration diagram of an intrusion detection and prevention system, according to an implementation of the present disclosure.

### DETAILED DESCRIPTION

Hereinafter, implementations of the present disclosure are described in detail with reference to the accompanying drawings. However, it should be understood that the technical spirit of the present disclosure is not limited to the implementations described below but may be implemented in many different forms. For example, it should be understood that within the scope of the present disclosure, one or more elements of each of the implementations may be selectively combined and substituted.

In addition, terms (including technical and scientific terms) used in the present disclosure have the same meanings as commonly understood by one of ordinary skill in the art to which the present disclosure pertains. It should be further understood that terms, such as those defined in commonly used dictionaries, should be interpreted as having meanings that are consistent with their meanings in the context of the related art.

Further, the terms used in the present disclosure are provided only to describe implementations of the present disclosure and not for purposes of limitation.

In this specification, the singular forms include the plural forms unless the context clearly indicates otherwise. Further, the phrase “at least one (or one or more) of an element A, an element B, and an element C,” should be understood as including the meaning of at least one of all possible combinations of the element A, the element B, and/or the element C.

Further, in describing elements of the implementations of the present disclosure, terms such as “first,” “second,” “A,” “B,” “(a),” and “(b)” may be used. These terms are used to distinguish an element from another element, but the nature, order, or sequence of the elements is not limited by these terms.

It should be understood that when an element is referred to as being “connected” or “coupled” to another element, the element may be directly connected or coupled to the other element, intervening elements may be present, or the element may be connected or coupled to the other element through still another element.

Further, when an element is described as being formed “on (above)” or “under (below)” another element, the term “on (above)” or “under (below)” includes not only a case in which two elements are in direct contact with each other, but also a case in which one or more elements are (indirectly) disposed between two elements. In addition, the term “on (above)” or “under (below)” means an upward direction as well as a downward direction based on one element.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, server, and the like may separately embody or be included with a processor and a memory, such as a non-transitory computer readable media, as part of the apparatus.

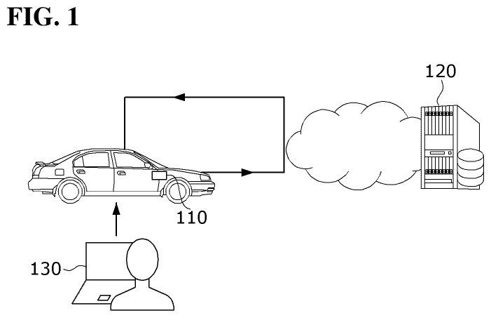

FIG. 1 is a diagram illustrating an example of an intrusion that may occur by a device outside a vehicle in the entire system in which an intrusion detection and prevention system in an in-vehicle network is connected to a server, according to an implementation of the present disclosure.

Referring to FIG. 1, an intrusion detection and prevention system 110 in an in-vehicle network may be connected to a server 120 through a communication network. The intrusion detection and prevention system 110 may be connected to the server 120 through a wireless communication network, but the present disclosure is not limited thereto. For example, the intrusion detection and prevention system 110 may be connected to the server 120 through wired communication. Further, although the intrusion detection and prevention system 110 is illustrated as being directly connected to the server 120 in FIG. 1, in another implementation the intrusion detection and prevention system 110 may be indirectly connected to the server 120 through another electronic device.

According to an implementation, the server 120 may be any one of an intrusion detection server, an intrusion prevention server, or an intrusion detection and prevention server. The server 120 may be operated by a manufacturer of the vehicle, but the present disclosure is not limited thereto. For example, the server 120 may be operated by a company providing related services. The server 120 may store an intrusion detection policy for detecting and/or preventing intrusions into the vehicle. The server 120 may store a plurality of intrusion detection policies. The intrusion detection policies may be determined based on at least one of the type of vehicle, the specifications, and/or the location of the vehicle.

According to an implementation, an intrusion may occur by a device 130 outside the vehicle. An intrusion into an in-vehicle network may occur wirelessly or by wire. According to an implementation, the intrusion may also occur by a server.

According to an implementation, the vehicle may include a plurality of electronic devices or electronic control units (ECUs). At least one of the ECUs may perform the functions of the intrusion detection and prevention system 110.

When the intrusion detection and prevention system 110 is turned on or the ignition (IG) of the vehicle is turned on, a program or software for intrusion detection and prevention may be executed. According to an implementation, the program or software for intrusion detection and prevention may load intrusion detection policies when it is first executed, and may not load the intrusion detection policy while the program or software is being executed. The intrusion detection policy may be decrypted when loaded, and may be encrypted or stored in a secure area when stored. When the intrusion detection and prevention system 110 is terminated or the IG is turned off, the program or software for intrusion detection and prevention may also be terminated. According to an implementation, the vehicle may store network intrusion-related logs and may transmit the stored logs to the server as necessary or requested.

When the server 120 is connected to the system as illustrated in FIG. 1, the server 120 may perform vehicle security threat analysis and risk assessment (TARA), may identify assets and functions of each ECU of the vehicle, and may derive expected attack scenarios and security measures targeting the assets. When testing of attack scenarios and corresponding security measures is completed, security measures corresponding to the attack scenario may be deployed to each vehicle. However, when an attack bypassing the security measures occurs, the intrusion detection and prevention system 110 may detect the attack in real time, but the security measures may be meaningless. Hereinafter, a method in which the intrusion detection and prevention system 110 detects an attack in real time and directly performs security measures, according to an implementation, is described in more detail.

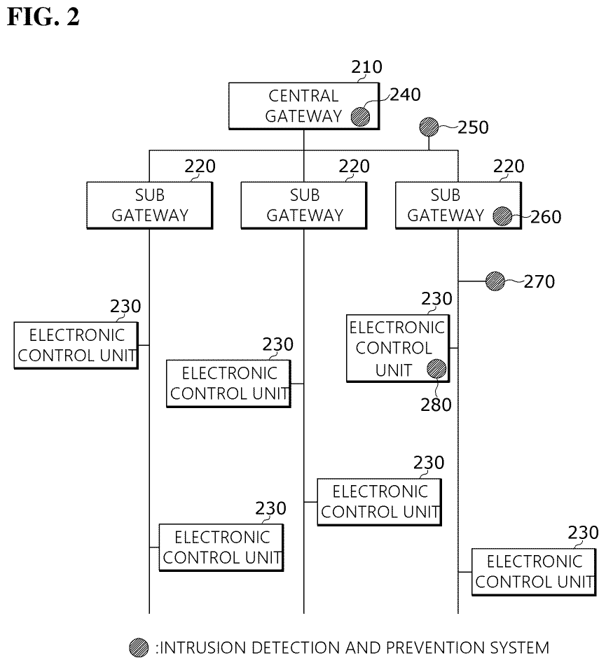

FIG. 2 is a diagram illustrating an example of a location at which an intrusion detection and prevention system may be placed in an in-vehicle network, according to an implementation of the present disclosure.

An intrusion detection and prevention system on an in-vehicle network may be installed on a path through which data from an external network to an internal network passes to prevent or block external intrusions.

Referring to FIG. 2, a central gateway 210 is a central communication node that acts as a router and may be viewed as a gate for all data entering a vehicle. The central gateway 210 may be connected to a sub gateway 220 and may transmit the received data to a corresponding domain. The sub gateway 220 is a local communication node that is in charge of a specific subsystem domain such as a power train, chassis, body, multimedia, etc. The sub gateway 220 may transmit the data received from the central gateway 210 to a corresponding ECU 230.

According to the implementation of FIG. 2, the intrusion detection and prevention system may be deployed in some of five locations on the in-vehicle network. For example, a first location may be inside the central gateway 210, a second location may be after the central gateway 210, a third location may be inside the sub gateway 220, a fourth location may be after the sub gateway 220, and a fifth location may be the ECU 230.

An intrusion detection and prevention system 240 placed inside the central gateway 210 may detect all attacks entering a network (e.g., a controller area network (CAN)) through a port (e.g., an on-board diagnostics (OBD)-II port). Therefore, messages with attack intent may be detected in advance. However, since too much data may be collected, it can be difficult to distinguish between attacks attempting to invade the internal network and messages that are not, so it may be difficult to respond to attacks effectively.

An intrusion detection and prevention system 250 placed after the central gateway 210, e.g., between the central gateway 210 and the sub gateway 220, may inspect messages that have passed through the message filtering of the central gateway 210. The intrusion detection and prevention system 250 may detect fewer attackers than the intrusion detection and prevention system placed inside the central gateway 210 but may detect attackers with stronger intentions. Further, the intrusion detection and prevention system 250 may detect hacking that directly accesses the network backbone from the outside and injects malicious messages.

An intrusion detection and prevention system 260 placed inside the sub gateway 220 may manage messages transmitted or received to or from a specific domain. For example, the intrusion detection and prevention system 260 may detect inconsistencies between messages after the central gateway 210 and messages transmitted or received to or from a specific domain. The intrusion detection and prevention system 260 placed inside the sub gateway 220 may detect attacks from within the domain to other domains, and thus may detect attackers within the domain at a certain degree or higher.

It is not easy to hack the system by passing through the double gateway with a specific malicious message. When the ECU 230 is corrupted by an attacker, when the ECU 230 is replaced with a malicious ECU 230 and disguised, or when there is a direct connection to a corresponding network bus from the outside, it may still be possible to transmit a malicious message. Therefore, an intrusion detection and prevention system 270 placed after the sub gateway 220, e.g., placed between the sub gateway 220 and the ECU 230, may be installed to monitor network hacking of a specific network domain to which the ECU 230 belongs because the ECU 230 cannot be trusted.

The ECU 230 may receive all messages present on the network and selectively process required messages by identifying IDs of the required messages. The ECU 230 may analyze and process the context of status messages and command messages that are received from the outside. In this case, the ECU 230 requires a high level of security because the ECU 230 should be protected from both the outside and the inside. An intrusion detection and prevention system 280 placed inside the ECU 230 may be installed to prevent loss of important data and malfunction of functions of the ECU 230 from highly capable internal or/and external attackers who can threaten the ECU 230.

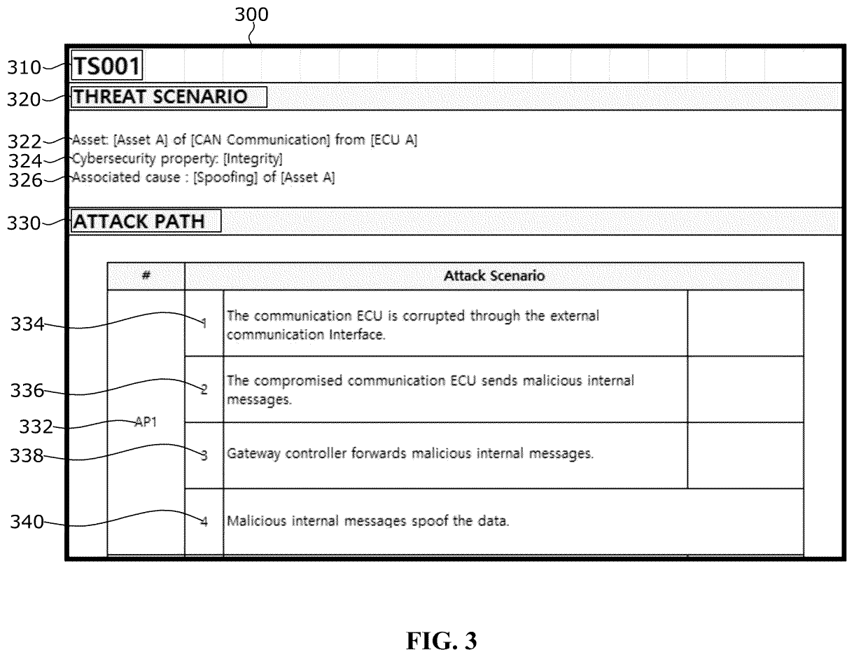

FIG. 3 is a diagram illustrating an example of a vehicle security TARA scenario, according to an implementation of the present disclosure.

Referring to FIG. 3, a vehicle security TARA scenario 300 may include a threat scenario number 310, information on the threat scenario 320, an attack path 330, etc. The vehicle security TARA scenario 300 may be based on the vehicle security TARA.

The threat scenario number 310 may be an identifier to distinguish one threat scenario from another threat scenario. The threat scenario number 310 may be a unique value, and the value itself may not have a meaning. The threat scenario number 310 may increase in value in sequence, for example, TS001, TS002, . . . , and other identifiers may be added.

The information on the threat scenario 320 may include information on a threat scenario. For example, the information on the threat scenario 320 may include at least some of assets 322, cybersecurity properties 324, and associated causes 326.

The asset 322 may represent a component of a vehicle that requires protection. For example, a sensor, a communication module, an ECU, etc. may be included in the assets 322. The asset 322 may be a hardware component or a software component. In the threat scenario shown in FIG. 3, data Asset A transmitted or received through CAN communication from ECU A indicates that it is a component of a vehicle that requires protection.

The cybersecurity properties 324 may represent properties that should be protected for vehicle system security. The cybersecurity properties 324 may be, for example, confidentiality, integrity, and availability. In an implementation, the confidentiality may be a property that protects data from being accessed by unauthorized users, and the integrity may be a property that ensures that data is not modified in an unauthorized manner. In addition, the availability may be a property that ensures that the system is always accessible and can operate normally when needed. The threat scenario shown in FIG. 3 indicates that the integrity is a property that should be protected for vehicle system security.

The associated causes 326 may indicate the cause or background of a specific threat. The associated cause 326 may include vulnerabilities or environmental factors that allow a threat actor to threaten the system, and thus, when the associated cause 326 is identified, specific measures may be prepared to reduce the possibility of a threat occurring. The threat scenario shown in FIG. 3 indicates spoofing of Asset A is the associated cause.

In addition, the associated causes 326 may further include, but not all of them need to be included, a threat actor that indicates the type of entity attempting the attack, an attack technique that indicates the technique used by the threat actor to threaten the asset, the objective (impact) that indicates the possible result of the attack, etc.

The attack path 330 represents a path through which a threat actor accesses the system, and may include physical access, remote wireless communication, internal network, etc. Referring to FIG. 3, an attack path 1 (AP1 ) 332 may be composed of four-stage attack scenarios. A first stage 334 may be “A communication ECU is corrupted through an external interface.” a second stage 336 may be “The corrupted communication ECU transmits malicious internal messages,” a third stage 338 may be “A gateway controller transmits malicious internal messages,” and a fourth stage 340 may be “The malicious internal messages spoof corresponding data.”

According to an implementation, the intrusion detection and prevention system may verify the transmitted message and thus pre-determine the second stage 336 as a detection stage.

Further, according to an implementation, the intrusion detection and prevention system may pre-determine the third stage 338 as a protection stage to prevent the malicious internal message from being transmitted thereafter.

The detection stage and the protection stage may be stages in which at least some attack paths are pre-determined. The detection stage and the protection stage may be transmitted by the server. The detection stage and the protection stage may be stored in a memory or a database.

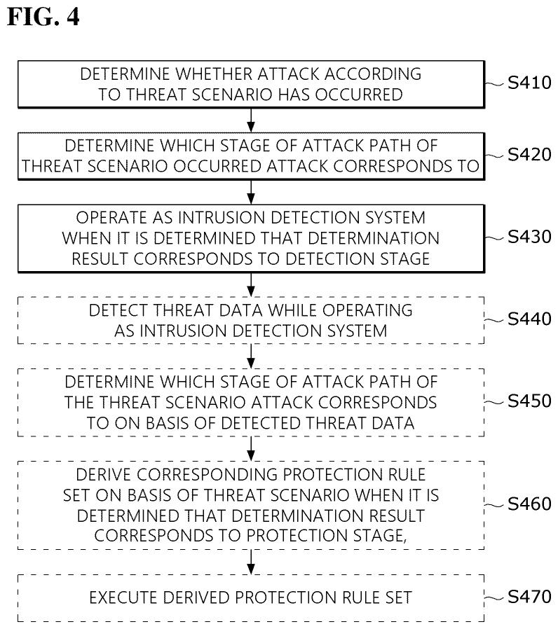

FIG. 4 is a flowchart of a process in which an intrusion detection and prevention system according to an implementation of the present disclosure detects and protects against threats within an in-vehicle network.

Referring to FIG. 4, in an operation S410, the intrusion detection and prevention system may determine that an attack according to a threat scenario has occurred. The threat scenario may be a threat scenario based on vehicle security TARA, and a detailed description thereof may be given with reference with FIG. 3.

In an operation, the intrusion detection and prevention system may determine which stage of an attack path of the threat scenario the attack corresponds to. The attack path may also be an attack path of a threat scenario according to vehicle security TARA. The attack path may be composed of a plurality of stages, and may include a detection stage for detecting threats and/or a protection stage for protecting assets from the detected threat. The detection stage and/or the protection stage may be stored in a memory or a database.

According to an implementation, the intrusion detection and prevention system may compare a rule set for detecting intrusions that is stored in the database with the attack path of the threat scenario. The intrusion detection and prevention system may derive a rule set for detecting intrusions that match each stage of the attack path of the threat scenario. However, when the intrusion detection and prevention system cannot derive a rule set for detecting intrusions that match each stage of the attack path of the threat scenario, the intrusion detection and prevention system may determine which stage of the attack path of the threat scenario the attack corresponds to using the detection stage and/or the protection stage stored in the database.

In an operation S430, when it is determined that a result of the determination corresponds to a detection stage, the intrusion detection and prevention system may operate as an intrusion detection system.

According to an implementation, in an operation S440, the intrusion detection and prevention system may detect threat data while operating as the intrusion detection system.

In an operation S450, the intrusion detection and prevention system may determine which stage of the attack path of the threat scenario the attack corresponds to on the basis of the detected threat data.

In an operation S460, when it is determined that the result of the determination corresponds to a protection stage, the intrusion detection and prevention system may derive or otherwise determine corresponding protection rule sets on the basis of the threat scenario.

In an operation S470, the intrusion detection and prevention system may execute the derived protection rule sets. At least one of the derived protection rule sets may be to block the transmission of related data. The intrusion detection and prevention system may block the transmission of threat data to prevent the threat data from being further transmitted.

According to an implementation, when threat data is detected, the intrusion detection and prevention system may transmit information on the detected threat data to the server. Here, the server may be a vehicle security operations center (VSOC). The intrusion detection and prevention system may also receive a protection rule set for the detected threat data from the server as necessary.

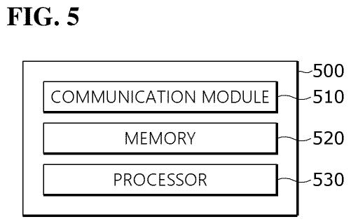

FIG. 5 is a configuration diagram of an intrusion detection and prevention system, according to an implementation of the present disclosure.

Referring to FIG. 5, an intrusion detection and prevention system 500 may include a communication module 510, a memory 520, and a processor 530.

The communication module 510 may be a component for the intrusion detection and prevention system 500 to transmit or receive data to or from other components. For example, the intrusion detection and prevention system 500 may use the communication module 510 to transmit information on threat data to a server or receive a protection rule set for the detected threat data from the server. As another example, the intrusion detection and prevention system 500 may use the communication module 510 to transmit or receive data to or from another component inside a vehicle, for example, an ECU.

The memory 520 may store various programs, software, and data required for the operation of the intrusion detection and prevention system 500. For example, a threat scenario, an attack path according to the threat scenario, corresponding protection rule sets based on the threat scenario, rule sets for detecting intrusions, etc. may be stored in the memory 520. In addition, a command for driving the processor 530 may be stored in the memory 520.

According to an implementation, the memory 520 may be referred to as a database, may include a database, or may be included in a database.

The processor 530 may cause the intrusion detection and prevention system 500 according to the present disclosure to perform its function. Specifically, the processor 530 may determine whether an attack according to the threat scenario has occurred, and when it is determined that an attack has occurred, determine which stage of an attack path of the threat scenario the determined attack corresponds to. Further, when it is determined that a result of the determination corresponds to a detection stage, the processor 530 may operate as an intrusion detection system. The threat scenario and the attack path may be based on vehicle security TARA, and the attack path may be composed of a plurality of stages including a detection stage and/or a protection stage. The detection stage and/or the protection stage may be stored in the memory 520.

The processor 530 may detect threat data while operating as the intrusion detection system, and may determine which stage of the attack path of the threat scenario the detected attack corresponds to on the basis of the detected threat data. When it is determined that the result of the determination corresponds to a protection stage, the processor 530 may derive corresponding protection rule sets on the basis of the threat scenario, and execute the derived protection rule set.

In addition, the processor 530 may use the communication module 510 to transmit information related to the detected threat data to the server or/and receive a protection rule set for the detected threat data from the server. Here, the server may be a VSOC.

According to an implementation, a corresponding one of the corresponding protection rule sets based on the threat scenario may be to block the transmission of related data, and thus the processor 530 may block the data transmitted or received through the communication module 510.

According to an implementation, the intrusion detection and prevention system 500 may be placed at one or more of inside the central gateway, between the central gateway and the sub gateway, inside the sub gateway, between the sub gateway and the ECU, and/or inside the ECU.

According to implementations of the present disclosure, a method of detecting and protecting against threats within an in-vehicle network and a system using the same are provided.

Further, according to implementations of the present disclosure, an intrusion detection and prevention system capable of detecting threats and performing security measures corresponding thereto even when an attack that bypasses security measures deployed in a vehicle occurs, and a system using the same are provided.

Effects obtainable in the present disclosure are not limited to the above-described effects and other effects that are not described may be more clearly understood by those of ordinary skill in the art from the above detailed descriptions.

While the present disclosure has been particularly described with reference to some implementations, the implementations are only illustrative and are not intended to limit the present disclosure. It should be understood by those having ordinary skill in the art that modified examples and applications in other forms may be made without departing from the spirit and scope of the present disclosure. For example, each component specifically shown in the implementations may be modified and embodied. In addition, it should be understood that differences related to these modified examples and applications are within the scope of the present disclosure as defined in the appended claims.

What is claimed is:

1. A method for detecting and preventing an intrusion in an in-vehicle network, the method comprising:
determining that an attack according to a threat scenario has occurred;
determining to which stage of an attack path of the threat scenario the attack determined to have occurred corresponds, wherein the attack path of the threat scenario includes a detection stage and a protection stage; and
based on determining that the stage of the attack path to which the attack corresponds is the detection stage, operating an intrusion detection and prevention system as an intrusion detection system.

2. The method of claim 1, further comprising:
detecting threat data while the intrusion detection and prevention system is operating as the intrusion detection system;
determining to which stage of the attack path of the threat scenario the attack corresponds based on the detected threat data;
based on determining that the stage to which the attack corresponds based on the threat data is the protection stage, determining protection rule sets based on the threat scenario; and
executing the determined protection rule sets.

3. The method of claim 2, further comprising transmitting information related to the detected threat data to a server.

4. The method of claim 3, wherein the server is a vehicle security operations center (VSOC).

5. The method of claim 3, further comprising receiving a protection rule set for the detected threat data from the server.

6. The method of claim 2, wherein the at least one of the protection rule sets determined based on the threat scenario is to block transmission of related data.

7. The method of claim 1, wherein the threat scenario and the attack path are a threat scenario and an attack path based on vehicle security threat analysis and risk assessment (TARA).

8. The method of claim 1, wherein determining to which stage of the attack path of the threat scenario the attack determined to have occurred corresponds includes comparing the attack path of the threat scenario with a rule set for detecting intrusions stored in a database.

9. An intrusion detection and prevention system comprising:
a communication module;
a memory; and
a processor configured to:
determine that an attack according to a threat scenario has occurred,
determine to which stage of an attack path of the threat scenario the attack determined to have occurred corresponds, wherein the attack path of the threat scenario includes a detection stage and a protection stage, and
based on determining that the stage of the attack path corresponds to the detection stage, operate as an intrusion detection system.

10. The intrusion detection and prevention system of claim 9, wherein the processor is configured to:
detect threat data while operating as the intrusion detection system,
determine to which stage of the attack path of the threat scenario the attack corresponds based on the detected threat data,
based on determining that the stage to which the threat scenario corresponds based on the detected threat data is the protection stage, determine protection rule sets based on the threat scenario, and
execute the determined protection rule sets.

11. The intrusion detection and prevention system of claim 10, wherein the processor is configured to use the communication module to transmit information related to the detected threat data to a server.

12. The intrusion detection and prevention system of claim 11, wherein the server is a vehicle security operations center (VSOC).

13. The intrusion detection and prevention system of claim 11, wherein the processor is configured to use the communication module to receive a protection rule set for the detected threat data from the server.

14. The intrusion detection and prevention system of claim 10, wherein at least one of the protection rule sets determined based on the threat scenario is to block transmission of related data.

15. The intrusion detection and prevention system of claim 9, wherein the threat scenario and the attack path are a threat scenario and an attack path based on vehicle security threat analysis and risk assessment (TARA).

16. The intrusion detection and prevention system of claim 9, wherein the processor is configured to determine to which stage of the attack path of the threat scenario the attack determined to have occurred corresponds to by comparing the attack path of the threat scenario with a rule set for detecting intrusions stored in a database.

17. The intrusion detection and prevention system of claim 9, wherein the intrusion detection and prevention system is provided as a plurality of intrusion detection and prevention systems placed at one or more of inside a central gateway, between the central gateway and a sub gateway, inside the sub gateway, between the sub gateway and an electronic control unit, or inside the electronic control unit.
